(19) United States
(12) Patent Application Publication
(10) Pub. No.: US 2014/0115001 A1
(43) Pub. Date: Apr. 24, 2014

(54) STRUCTURED QUERY GENERATION

(71) Applicant: PLAYENCE GMBH, Innsbruck (AT)

(72) Inventors: Sinuhe Arroyo, Segovia (ES); Jose Manuel Lopez Cobo, Segovia (ES); Guillermo Alvaro Rey, Segovia (ES); Silvestre Losada Alonso, Segovia (ES)

(73) Assignee: playence GmBH, Innsbruck (AT)

(21) Appl. No.: 13/732,744

(22) Filed: Jan. 2, 2013

Related U.S. Application Data
(60) Provisional application No. 61/715,977, filed on Oct. 19, 2012.

(51) Int. Cl. G06F 17/30

(52) U.S. Cl. CPC G06F 17/30985
USPC 707/772

(57) ABSTRACT

A system and method for information retrieval system are presented. A graph generation module is configured to output, to a client computer, a graph depicting a first arrangement of a subset of a plurality of entities of a knowledge model, the graph depicting a relationship between ones of the subset of the plurality of entities. A node selection reception module is configured to receive, from the client computer, a selection of at least one of the subset of the plurality of entities and an associated action, wherein, when the associated action is of a first type, the graph generation module is configured to output, to the client computer, a second graph depicting a second arrangement of a second subset of the plurality of entities of the knowledge model using the selected at least one of the subset of the plurality of entities. A query generation module is configured to, when the associated action is of a second type, generate a query string using the selected at least one of the subset of the plurality of entities.

### CROSS-REFERENCE TO RELATED APPLICATIONS

This application claims priority to and incorporates by reference U.S. Provisional Patent Application No. 61/715,977 entitled “STRUCTURED QUERY GENERATION BY WAY OF BROWSING TOOL” and filed on Oct. 19, 2012.

### FIELD OF THE INVENTION

The disclosure relates in general to an electronic system for querying a database and, more particularly, to a method and apparatus for generating a structured query for executing a search within a database.

### BACKGROUND

Conventional electronic search and information retrieval systems require that a user construct a query that can be easily executed by the retrieval system. The query is generally an expression constructed using natural language, keywords, operators, and/or combinations thereof. After the query constructed by the user is executed, a set of results is generated.

In many cases, it can be difficult for a user to find the desired information using such an unstructured query approach. If, for example, the user selects an incorrect keyword (e.g., by searching for “cop” when the desired content uses the word “policeman”), the desired content will not be found. Similarly, a single keyword may have many meanings, where the user is only interested in content associated with one of those meanings. In either case, it can be difficult for the user to quickly and efficiently find desired content within an information retrieval system.

Several approaches exist to minimize the problems associated with conventional unstructured-query searching. In particular, ontology-powered approaches and semantic technologies have been developed to understand a user's “desired” search and structure the listing of results based upon that estimated desire. These approaches usually involve converting the user's natural language query into a structured, semantic query. That semantic query can then be executed by an information retrieval system to generate an improved listing of results.

To enable the semantic operation, candidate search terms and phrases are related in an ontology. An ontology is a database or table that interrelates search terms by defining a number of relationships that may exist between those terms. The ontology can then be used to analyze the user's inputted search phrase to more accurately identify the user's desired search terms. Although ontology-driven information retrieval systems have been developed, the ontologies driving such systems are generally hidden from a user. As such, in conventional information retrieval systems, ontologies are only employed after the user has already provided a query in an attempt to determine the user's actual desired search terms.

### BRIEF SUMMARY

The disclosure relates in general to an electronic system for querying a database and, more particularly, to a method and apparatus for generating a structured query for executing a search within a database.

In one implementation, the present invention is an information retrieval system, comprising a knowledge model database configured to store a knowledge model for a knowledge domain. The knowledge model defines a plurality of entities and interrelationships between one or more of the plurality of entities. The system includes a knowledge base configured to identify a plurality of items, and associate at least one of the plurality of items with at one of the entities in the knowledge model. The system includes a graph generation module configured to output, to a client computer, a graph depicting a first arrangement of a subset of the plurality of entities of the knowledge model, the graph depicting a relationship between ones of the subset of the plurality of entities, and a node selection reception module configured to receive, from the client computer, a selection of at least one of the subset of the plurality of entities and an associated action, wherein, when the associated action is of a first type, the graph generation module is configured to output, to the client computer, a second graph depicting a second arrangement of a second subset of the plurality of entities of the knowledge model using the selected at least one of the subset of the plurality of entities. The system includes a query generation module configured to, when the associated action is of a second type, generate a query string using the selected at least one of the subset of the plurality of entities.

In another implementation, the present invention is an information retrieval system, comprising a graph generation module configured to output, to a client computer, a graph depicting a first arrangement of a subset of a plurality of entities of a knowledge model, the graph depicting a relationship between ones of the subset of the plurality of entities, and a node selection reception module configured to receive, from the client computer, a selection of at least one of the subset of the plurality of entities and an associated action, wherein, when the associated action is of a first type, the graph generation module is configured to output, to the client computer, a second graph depicting a second arrangement of a second subset of the plurality of entities of the knowledge model using the selected at least one of the subset of the plurality of entities. The system includes a query generation module configured to, when the associated action is of a second type, generate a query string using the selected at least one of the subset of the plurality of entities.

In another implementation, the present invention is a method, comprising providing a knowledge model database configured to store a knowledge model for a knowledge domain, outputting, to a client computer, a graph depicting a first arrangement of a subset of a plurality of entities of the knowledge model, the graph depicting a relationship between ones of the subset of the plurality of entities, and receiving, from the client computer, a selection of at least one of the subset of the plurality of entities and an associated action. The method includes, when the associated action is of a first type, outputting, to the client computer, a second graph depicting a second arrangement of a second subset of the plurality of entities of the knowledge model using the selected at least one of the subset of the plurality of entities, and when the associated action is of a second type, generating a query string using the selected at least one of the subset of the plurality of entities.

### BRIEF DESCRIPTION OF THE DRAWINGS

FIG. 1 is a block diagram illustrating one example configuration of functional components of an information retrieval system.

FIG. 2 is a block diagram showing functional components of a query generation and processing system.

FIG. 3 is a flowchart illustrating a exemplary method for performing a query in accordance with the present disclosure.

FIG. 4 is a flowchart illustrating an exemplary method for generating a query that involves a user navigating through a knowledge model and adding restrictions on the browsed entities of that knowledge model.

FIG. 5 is a depiction of an exemplary user interface displaying a potential visualization of an initial node-based graph having a root node and a number of linked top-level concepts.

FIG. 6 is a depiction of a user interface displaying a node-based graph featuring multiple relationships between nodes.

FIG. 7 is a depiction of a second user interface displaying a node-based graph featuring multiple relationships between nodes.

FIGS. 8-14 are depictions of user interfaces depicting views of a node-based knowledge model graph that enables a user to navigate the knowledge model and select entities therefrom for construction of a query.

### DETAILED DESCRIPTION OF THE DRAWINGS

The disclosure relates in general to an electronic system for querying a database and, more particularly, to a method and apparatus for generating a structured query for executing a search within a database.

This invention is described in embodiments in the following description with reference to the Figures, in which like numbers represent the same or similar elements. Reference throughout this specification to “one embodiment,” “an embodiment,” “one implementation,” “an implementation,” or similar language means that a particular feature, structure, or characteristic described in connection with the embodiment is included in at least one embodiment of the present invention. Thus, appearances of the phrases “in one implementation,” “in an implementation,” and similar language throughout this specification may, but do not necessarily, all refer to the same embodiment.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Any schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present system and method provides an improved information retrieval system that extends current approaches for information retrieval. The system enables a user to navigate an ontology or knowledge model using a simple to operate visual interface. As the user navigates the knowledge model, the user selects items from the knowledge model and constructs a search query that accurately represents the user's desired search. That query can then be executed by the information retrieval system to generate a list of results for the user.

For a given subject matter, the present system provides both a knowledge model and a knowledge base. The knowledge model includes an ontology that defines concepts, entities, and interrelationships thereof for a given subject matter or knowledge domain. The knowledge model, therefore, normalizes the search terms for a given subject matter domain.

The knowledge base, in contrast, is the store of information that the information retrieval system is configured to search. The knowledge base is a database including many items (or references to many items) where the items can include many different types of content (e.g., documents, data, multimedia, and the like) that a user may wish to search. The content of the knowledge base can be stored in any suitable database configured to store the contents of the items and enable retrieval of the same. To facilitate searching, the items in the knowledge base can each be associated with different concepts or entities contained within the knowledge base. This association can be made explicitly (e.g., through the use of metadata associated with the content), or implicitly by the item's contents. With the knowledge base catalogued in accordance with the knowledge model, the knowledge model becomes an index or table contents of contents by which to navigate the contents of the knowledge base.

In the present system the user first navigates the knowledge model to construct a desired search query. The user can then explore the knowledge model to inspect the different concepts or entities contained therein, as well as their relationships. As the user navigates the knowledge model, the user can select particular terms or concepts for inclusion in the search query.

After the query is constructed, the query can be executed against the knowledge base. Because the contents of the knowledge base are indexed against the various terms and concepts of the knowledge model, the query will map accurately to the knowledge base's contents, ensuring that the results of the search accurately relate to the user's desired search.

In the present system, to facilitate the user navigating the knowledge model, the user is present with a visual representation or graph of the knowledge model's contents. The knowledge model graphs sets out, in a two-dimensional space, a number of entities or concepts contained within the knowledge model. The entities or concepts are then interrelated by a number of visual indicators (e.g., a solid line, dashed line, or colored line) that indicates the type of relationship that two or more of the entities or concepts may have. Each node of the graph, therefore, can indicate an entity or concept selected from the knowledge model.

In this disclosure the “graph structure” is to be understood in a broad sense as a visual representation of a set of entities that may each be interrelated through formal relationships. As a user navigates through the knowledge model, the user is able to construct a formal search query using the contents of the knowledge model. As the user selects elements from the knowledge model for addition to the query, the elements can be associated with a number of different restrictions. In one implementation, the user selects items for a Boolean search query structure (i.e., stating that each selected knowledge model item has to be or cannot be present in the set of results). Alternatively, more complex three-valued approaches are also possible. In some cases, the selected items from the knowledge based related in the search query through the application of different weights applied to each of the selected items via fuzzy restrictions, etc., as described below.

Because the knowledge model (and the underlying ontology) sets out in a logical fashion the various concepts and entities of a particular subject matter, it can be intuitive for users to navigate through the knowledge model from item to item using the defined relationships between those items. By browsing through the knowledge model and selecting and placing constraints on one or more of the model's entities, users are able to formulate a structured query to accurately locate the desired information within the knowledge base. Additionally, because the user interface that allows the users to navigate the knowledge model is intuitive, the user is able to easily explore and discover and use more relevant entities from the knowledge model.

Once the structured query has been created, the query is matched against the repository of documents or items stored within the knowledge base. As those documents have been indexed along those entities from the domain knowledge, the set of documents eventually returned is relevant for the generated query.

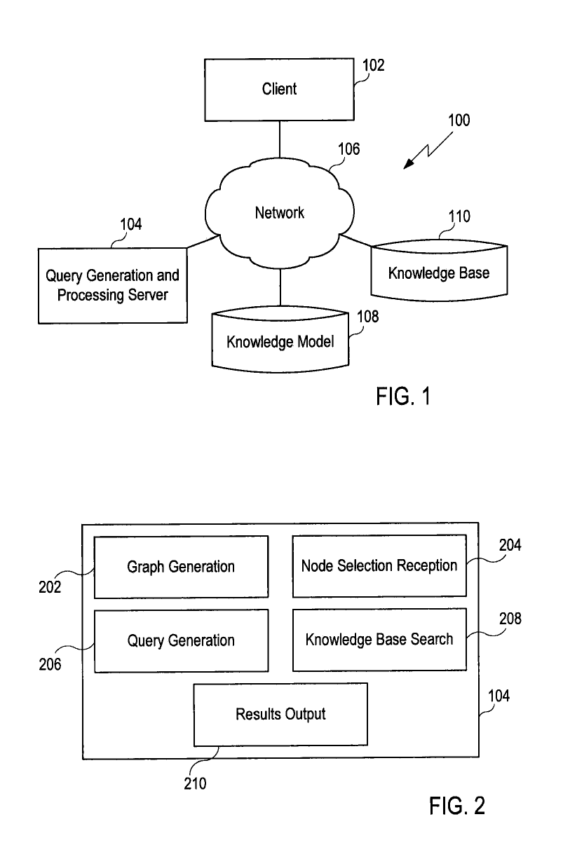

FIG. 1 is a block diagram illustrating one example configuration of the functional components of information retrieval system 100. System 100 includes client 102. Client 102 includes a computer executing software configured to interact with query generation and processing server 104 via communications network 106. Client 102 can include a conventional desktop computer or portable devices, such as laptops computers, smartphones, tablets, and the like. A user uses client 102 to browse the knowledge model by manipulating a node-based graph that depicts the entities of the knowledge model and their interrelationships. The user can also use client 102 to construct a search query by associating restrictions (e.g., the Boolean restrictions “has to appear”/“cannot appear”) with various entities of the knowledge model. After a search is created and executed, client 102 depicts the search results for review by the user.

Query generation and processing server 104 is configured to interact with client 102 to both depict the knowledge model and allow the user to manipulate the same to create a search, as well as executed the search after the query is complete. Although in FIG. 1 these two functions are depicted as being executed by the same device, the two functions could be distributed across a number of different devices. To depict the knowledge model for the user and to allow manipulation of the same, Query generation and processing server 104 accesses knowledge model database 108, which contains the knowledge model (i.e., the concepts, instances and relationships that define the subject matter domain). Once a query has been created, query generation and processing server 104 executes the query against knowledge base database 110, which stores the knowledge base and any metadata describing the items of the knowledge base. In knowledge base database 110, the items to be retrieved are generally annotated with one or more of the terms available in the knowledge model.

In the present disclosure, when describing the knowledge model, or the underlying ontology of the knowledge model, the following naming conventions may be used. However, other knowledge model structures may be utilized through similar models employing a graphical structure that relates entities of an ontology through formal relationships, but with different naming conventions.

The present knowledge model is composed of different ontological components.

“Concepts” (e.g., classes) are abstract objects of a given knowledge domain such as categories or types. An example of a concept would be “actor”, “director” or “movie” for a knowledge domain involving cinema.

“Instances” (e.g., individual objects) are concrete objects in the given knowledge domain. Examples includes a given actor such as “Marlon Brando” or a movie like “The Godfather”.

“Entities” refer to both Concepts and Instances, i.e., the nodes in the knowledge graph.

“Relationships” (e.g., relations) specify how objects in the knowledge model relate to other objects. For example, the relationship “appears in” links the concept “actor” with the concept “movie.” Relationships can also relate instances. For example, the relationship “appears in” relates instance “Marlon Brando” with the instance “The Godfather”.

A knowledge model may be constructed by hand, where engineers (referred to as ontology engineers) lay out the model's concepts, instances and relationships and the relationships thereof. This modeling is a process where domain-specific decisions need to be taken, and even though there exist standard vocabularies and ontologies, it is worth noting the same domain may be modeled in different ways, and that such knowledge models may evolve over time. Sometimes the semantic model is used as a base and the model's individual components are considered static, but the present system may also be implemented in conjunction with dynamic systems where the knowledge model varies over time.

As mentioned above, the present system uses two well-differentiated data repositories; the knowledge model and the knowledge base.

The knowledge model repository (stored, for example, in knowledge model database 108) contains the relationships amongst the different types of entities in the knowledge domain. The knowledge model identifies both the “schema” of abstract concepts and their relationships, such as the concepts “actor” and “movie” connected through the “appears in” relationship, as well as concrete instances with their respective general assertions in the domain, such as concrete actors like “Marlon Brando” or directors like “Francis Ford Coppola”, and their relationship to the movies they appear on, or have directed, etc.

One possible implementation of the knowledge model, considering the particular example of semantic (ontological) systems could be a “triplestore”—a repository (database) purposefully built for the storage and retrieval of semantic data in the form of “triples” (or “statements” or “assertions”). “Triples” are data entities that follow a subject-predicate-object (s,p,o) pattern, being the subject and object concepts or instances of the semantic model, and being the predicate a relationship. An example of such a triple is (“Marlon Brando”, “appears in”, “The Godfather”). A semantic data model widely extended for expressing these statements is the Resource Description Framework (RDF). Query languages like SPARQL can be used to retrieve and manipulate RDF data stored in triplestores.

It is worth noting that the triplestore arrangement is just a possible implementation of a knowledge model, in the case that a semantic model is used. However, other types of repositories able to define the entities and relationships of the knowledge model may also be used.

The knowledge base is the repository that contains the items or content that the user wishes to search and retrieve. The knowledge base may store many items including many different types of digital data. The knowledge base, for example, may store plain text documents, marked up text, multimedia, such as video, images and audio, programs or executable files, raw data files, etc. The items can be annotated with both abstract concepts (e.g., “actor”) and particular instances (e.g., “Marlon Brando”) selected from the knowledge model, which are particularly relevant for the given item. One possible implementation of the knowledge base is a Document Management System that permits the retrieval of documents via an index of the entities of the knowledge base. To that end, documents in the repository need to be associated to (or “annotated with”) those entities.

The techniques described herein can be applied to repositories of documents in which annotations have been performed through different manners. The process of annotation for the documents may have been performed both manually, with users associating particular concepts and instances to the document to particular entities in the knowledge model, and/or automatically, by detecting which references to entities appear in each knowledge base item. Systems may provide support for manual annotations by facilitating the user find and select entities from the knowledge model, so these can be associated to items in the knowledge base. For example, in a possible embodiment, the system may offer auto-complete functionality so when the user begins writing “Marlon”, the system might suggest “Marlon Brando” as a particular instance that the user could choose. The user may decide then to annotate a given item with the chosen instance, i.e., to specify that the entity from the knowledge model is associated to the particular item in the knowledge base.

When automatically creating metadata for the knowledge base items, techniques like text parsing and speech-to-text over the audio track or a multimedia item can be used along with image processing for videos. In this manner, it is possible to associate each of the items in the knowledge base (or even portions of the items), with the entities in the domain knowledge. This process is dependant on the knowledge model because the identification of entities in the knowledge base item is performed in reliance upon the knowledge model. For example, the visual output of certain documents (e.g., images or video) can be analyzed using optical character recognition techniques to identify words or phrases that appear to be particularly relevant to the document. These words or phrases may be those that appear often or certain words or phrases that may appear in a corresponding knowledge base. For example, when operating in the theatre knowledge domain, when a document includes words or phrases that match particular concepts, instances, relationships, or entities within the knowledge domain (e.g., the document includes the words “actor”, “Al Pacino”, and “Marlon Brando”) the document can be annotated using those terms. For documents containing audio, the audio output can be analyzed using speech to text recognition techniques to identify words or phrases that appear to be particularly relevant to the document. These words or phrases may be those that are articulated often or certain words or phrases that may appear in a corresponding knowledge base. For example, when operating in the theatre knowledge domain, when a document includes people discussing particular concepts, instances, relationships, or entities within the knowledge domain the document can be annotated using those terms.

Additionally, a combination of approaches (semi-automatic techniques) is also possible for annotating the knowledge base. The result of such annotation techniques is that the documents in the knowledge base repository are then indexed with metadata according to the entities (knowledge model concepts and/or instances) that appear in or have been associated to the items.

In the case of manual annotation, terms that belong to the knowledge model are associated with the items in the knowledge base. Different techniques for encouraging users to participate in the manual annotation of content may be applied, like the use of Games with a Purpose to leverage the user's interactions while they play. Again, the underlying knowledge model and the model's design defines the kinds of annotations that can be applied to the items in the knowledge base.

FIG. 2 is a block diagram showing the functional components of query generation and processing server 104. Query generation and processing server 104 includes a number of modules configured to provide one or more functions associated with the present information retrieval system. Each module may be executed by the same device (e.g., computer or computer server), or may be distributed across a number of devices.

Graph generation module 202 is configured to generate a node-based graph depicting a number of entities from the knowledge model and their interrelationships. The node-based graph is then presented to the user via a client computer (e.g., client 102 of FIG. 1). The users can interact with the graph by selecting particular entities for inclusion within a query, or by navigating through the knowledge model by manipulating the graph.

Node selection reception module 204 is configured to receive the selection of nodes of the knowledge model by the user on the client 102, and/or the user performing a particular action on a node (e.g., expanding the node to continue navigation, or adding or removing a node from a query restriction).

Query generation module 206 receives an identification of the selected node from node selection reception module 204 and uses the selected node (and the restrictions associated therewith) to generate a structured query that may be executed against the knowledge base.

Knowledge base search module 208 uses the query generated by query generation module 206 to retrieving items from the knowledge base (or links thereto) that are relevant to (i.e., that satisfy the requirements of) the query.

Results output module 210 retrieves the items (or links thereto) that are relevant to the executed query and provides an appropriate output to the user on client 102. In addition to the items themselves, results output module 210 may be configured to generate statistics or metrics associated with the resulting items and depict that data to the user. Results output module 210 may also depict a graph showing the relevant knowledge model entities that are present in the search results. The user can then select one or more of those relevant knowledge model entities to further browse and specify restrictions to the query results.

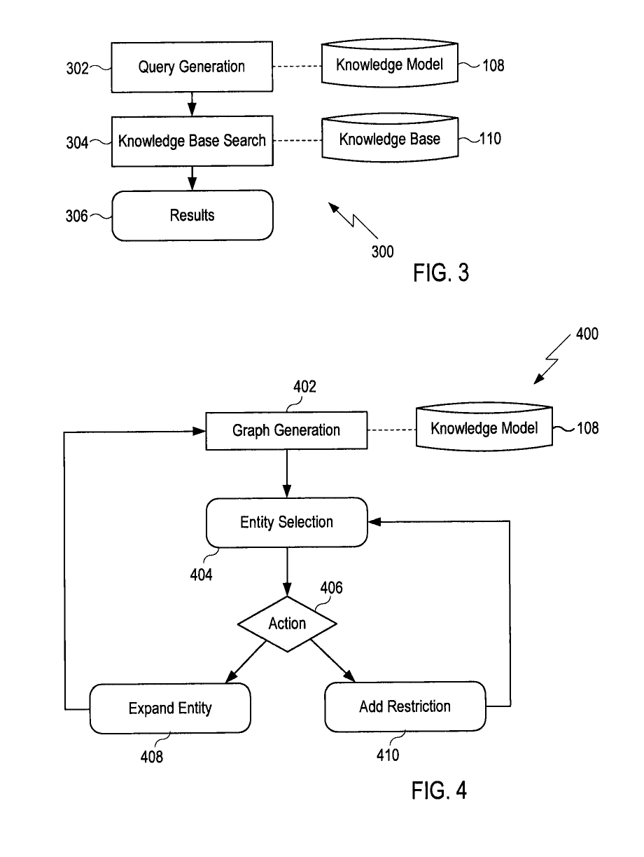

FIG. 3 is a flowchart illustrating a relatively high-level method 300 for performing a query in accordance with the present disclosure. In step 302 a query is generated. During execution of step 302 a graph generation module (e.g., module 202) generates a graph depicting elements of a knowledge model that can be navigated by a user. As the user navigates the knowledge model, entities from the knowledge module are added to a query. The user's interactions with the knowledge model graph can be governed by a node selection reception module (e.g., module 204). As the user selects entities from the knowledge module and adds those entities to a query, a query generation module (e.g., module 206) constructs the corresponding query. During execution of step 302, knowledge model database 108 is accessed (indicated by the dashed line) in order to retrieve the contents of the knowledge model and depict the knowledge module graph and allow the user's interactions therewith.

After the query is constructed, in step 304 the query is executed against knowledge base database 110 (indicated by the dashed line). After the query is executed, the results (including, for, example, a listing of items from the knowledge base that satisfy the query) are depicted for the user in step 306.

FIG. 3 illustrations method 300 as a single operational flow. However, method 300 can be repeated any number of times, alternating between the generation of queries and the use of queries to search over the repository of documents in the knowledge base. This enables searches in an iterative manner, making it possible to refine the search results through further navigation.

FIG. 4 is a flowchart illustrating method 400 for generating a query in accordance with the present disclosure, which involves the user navigating through the knowledge model and adding restrictions on the browsed entities of that model.

In step 402, graph generation is performed. The graph depicts entities of the knowledge model and their relationships. For the first graph generation, this step can be initiated by taking as input any chosen initial graph structure featuring parts of the domain knowledge, e.g., a combination of relevant entities, or the top-level ones in a hierarchy, etc. Each subsequent time a graph is generated, the user-selected node (or nodes) of the graph can be used to create the relevant graph.

During graph generation, knowledge model database 108 is used for the generation of the graph, as the database identifies the entities and relationships that are to be displayed. During step 402, the knowledge model graph is displayed for the user, and the user is able to interact with the graph. For example, in step 404 the user can select one of the depicted nodes in an entity selection step. From an implementation point of view, the selection of an entity may be achieved by clicking, browsing over, using keyboard means, or any other way.

Embodiments of the present system may implement the graph construction through different approaches. For example, it may be decided that only a relevant subset of entities are depicted within the graph, in order not to clutter the view in excess. The concept of relevancy in this context may be decided using different criteria, for example with an arbitrary list of entities considered important, or taking into account the number of relationships of each entity, etc. Therefore, embodiments may limit the number of items displayed, as well as restrict other configuration options such as the number of jumps from node to node that users may perform through their browsing.

Once an entity of the knowledge model has been selected, in step 406 an action may be performed upon the selected entity. Again, the performing of the action may be implemented through different means. For example, through clicking, double-clicking, via a modal panel through secondary-button clicking, etc., or even seamlessly by just moving the mouse over the node. Independently of the actual implementation of the action selection, two action types may be performed by the user.

In step 408 a first action is performed to expand the selected entity of the knowledge model graph. When the entity action is performed, a new graph is generated where the selected node at least partially determines the content to be displayed in the new display.

Alternatively, the user could select an alternative action. In step 410 a second action is performed to add a query restriction utilizing the selected entity. In this step, the user may also select the type of restriction to be associated with the entity when the entity is added to the query. A simple type of restriction that may be selected by the user includes Boolean options such as “AND” (denoting that the selected entity has to be present in the results retrieved by the system) and “NOT” (meaning that the selected entity cannot be present in the results retrieved by the system). Boolean restrictions are not the only possibility; embodiments of the present system may provide more complex restrictions too, by including other options like allowing users specify a weight to be associated with one or more entities in the query, for example.

After the restriction has been added in step 410, a new entity may be selected on the knowledge model graph allowing the user to execute new actions upon the newly selected entity.

At any time, the user may finish the process and choose to execute a knowledge base search using the query created by the user. At that point the query generated according to method 400 is used. As explained above, the browsing process does not necessarily need to be stopped when the search is performed; the system may allow the user to continue navigating, triggering the search process in a separate window, etc. Additionally, the system may provide an opportunity for users to discard the restrictions previously specified at any given point.

Thus far, navigation through the knowledge model has been described from node to node via the relationships that link them, but the present system may provide additional ways to access and expand each node in different manners allowing for alternative means to navigate the knowledge model. For example, the system may provide a way to select a particular node through a drop-down menu or in a text-based form with auto-completion functionality, so the user is able to jump to another part of the model at any given time, etc.

When generating a graph of one or more entities of the knowledge model, the graphs are generated by depicting the entities that are considered relevant at a given time, along with the relationships that link them. Two types of entities, already mentioned above, are considered for the graph, although the system may implement only one of them, or both, or in combination with more types, etc.:

“Concepts”: Classes, abstract objects. Examples: “Movie”, “Person” “Actor”, “Director”, “Writer”, “Character”.

“Instances”: Individual, concrete objects. Examples: “The Godfather” (instance of “Movie” concept), “Marlon Brando” (instance of “Actor” concept), “Vito Corleone” (instance of “Character” concept).

The types of relations through which the depicted entities can be associated to each other are also of various types. Again, three different types are listed below in order to illustrate different possibilities; however, other implementations may consider and implement any of them, or combinations, or even include additional types, etc.:

“Relationships”: Relationships specify the direct relations amongst entities in the knowledge model. Examples: “Appears in” (links “Actor” and “Movie” concepts, and so does with the “Marlon Brando” and “The Godfather” instances).

“Hierarchy”: Concepts can be arranged as being “above” or “below” one another through subclasses/superclasses. For example, concept C1 is a subclass of concept C2 if there is an “is a” relation amongst them (i.e., “C1 is a C2”). Examples: “Actor”, “Director” and “Writer” concepts are subclasses of the “Person” concept.

“Belongs to”: Instances are related to concepts through the “belongs to” relation. An instance I is said to belong to concept C if the abstract type of the instance matches the concept. Examples: “The Godfather” instance belongs to the “Movie” concept, “Marlon Brando” instance belongs to the “Actor” concept, and “Vito Corleone” instance belongs to the “Character” concept.

Based on these considerations of the types of entities and relations amongst then, a graph can be generated by taking a given entity as starting point and presenting the nodes which are directly related to that given entity. Some implementations may also take as starting point several entities and not only one. The same consideration applies to the nodes that are to be included in the graph; for instance those at “distance 2” (not directly connected to each other, but directly connected both to a third entity) may also be included in the graph.

The first time a graph is generated based upon a knowledge model, there may not be an entity selected by a user (although it may also be the case that the process begins with an entity selected through any other means, e.g., via menu, form, etc.). When no entity is selected, different options for the graph generation may be implemented. For example, in the case of an ontological model, this can be arbitrarily done from the root of the ontology, featuring the top-level concepts in the hierarchy, or selecting a set of important entities within the domain, etc.

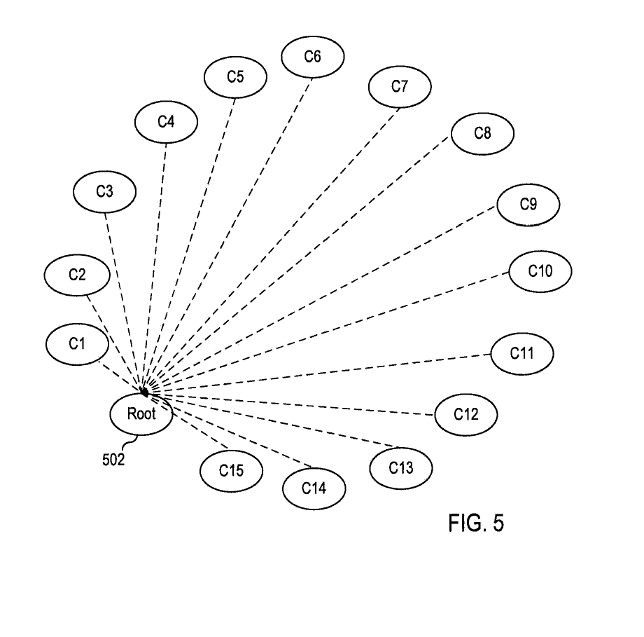

From a formal point of view, a knowledge model with a graph structure can be represented in different ways. An arbitrary option is to represent every pair of connected entities Ci and Cj as (Ci,Cj) in this case without making the relationship amongst them explicit. While other representations are possible, this representation may be considered for example purposes. Accordingly, if the initial graph is arbitrarily generated from the root of the model, with 15 top-level concepts in the hierarchy, the whole graph could then be represented as a set of pairs like {(Root, C1), (Root, C2), . . . , (Root, C15)}. FIG. 5 depicts a potential visualization of such initial node-based graph, with the Root node 502 highlighted, and the top-level concepts (C1 to C15) linked to the Root node through a dotted line that represents a hierarchy relationship.

When one of the entities depicted in the graph is selected and expanded by the user (e.g., by clicking on the entity and performing an expansion function on the entity), the graph generation process is executed again, taking into account the selected entity.

In one implementation, the graph may be completely re-generated; alternatively, new nodes or entities may be added to the existing graph depiction, with some existing entities being hidden or modified. In the case of a completely new graph being generated, one option is to focus the new graph on the latest selected node. However, embodiments may consider several nodes at the same time for graph generation. If the graph is generated over the newly selected node, the chosen entity (a concept in the case of the ongoing example) is highlighted, and the graph also represents the concepts that are related to it both through direct relationships and hierarchically related (subclasses and superclasses of the selected concept), and those which have a direct relationship in the domain knowledge model. Besides the node-based graph, the instances that belong to the given concept are featured. Again, different mechanisms can be employed to represent the list of relevant instances, either directly in the graph, or through other options like alphabetically ordered elsewhere in the system, and paginated if the number is too high, etc.

Referring to the example graph depicted in FIG. 5, a new graph may be generated after one of the entities depicted on FIG. 5 is selected and expanded by a user. For example, should the user expand concept C8, the new graph could be formally represented in different ways in order to feature both the relationship connections and the hierarchical ones (subclasses). One of such possible representations would be like {relationships={(C8, C1), (C8, C4), . . . , (C8, C6)}, subclasses={(C8, C16), (C8, C17), (C8, C18)}}. A set of instances that belong to the chosen concept C8 could be represented, for example, as {I1, I2, . . . I32}.

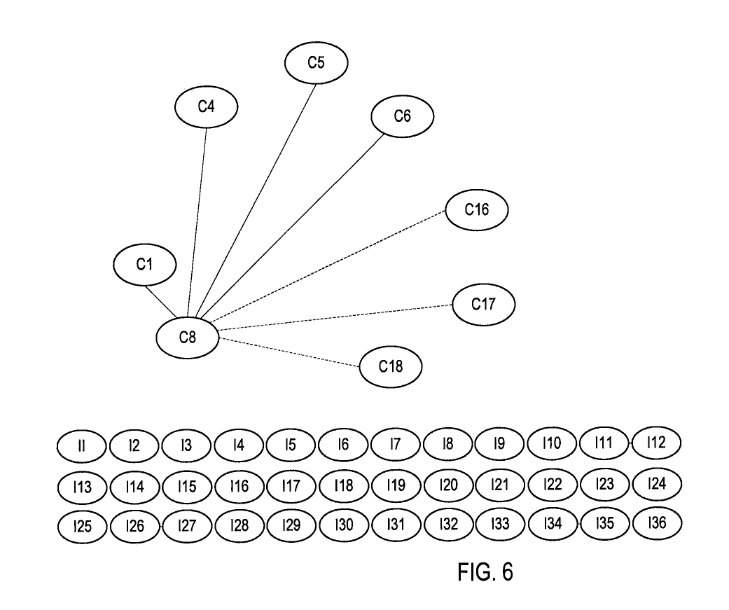

FIG. 6 shows such a graph featuring two types of lines for the hierarchy relations (dashed lines) and the direct relationships (solid lines), also including the set of related instances below the graph. Again, the visualization decisions are arbitrary, and all the elements may have been represented through different means, e.g., by featuring the instances linked within the graph itself.

Instances may also be selected and expanded. In this case, the same considerations apply in terms of the graph generation process. A new graph may be generated, or either the previous one modified. If a new graph is generated, it may be focused on the chosen instance; along with it, other instances to which there is a direct relationship can be depicted, as well as the concept to which the selected instance belongs. (Or the several concepts to which the instance belongs, if that is the case.)

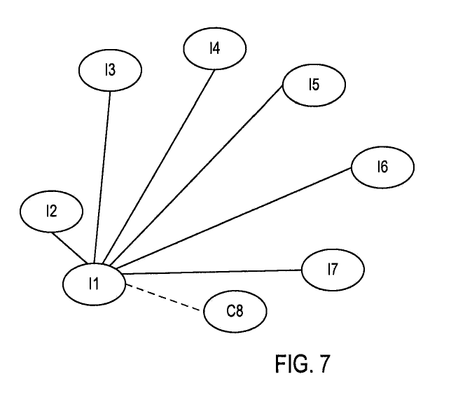

In this example, one possible formal representation of a graph focused on an instance would be {relationships={(I1, I2), (I1, I3), . . . , (I1, I7)}, belongs={(I1, C8)}}. FIG. 7 depicts a graph using solid lines for the direct relationships amongst the selected instance I1 and other entities, and a dashed line to represent the “belongs to” relation between the selected instance I1 and its respective concept.

As the user browses the knowledge model, the user adds entities from the knowledge model (in combination with an associated restriction) to the query. Each restriction is applied iteratively to the knowledge model entities that are present within the query. Different types of restrictions may be included in the query, depending on the actual implementation of the system. Example restrictions include an “AND” restriction (meaning that the selected entity has to appear in the results) and a “NOT” restriction (meaning that the selected entity cannot appear in the results) restrictions. However, more complex restrictions might be specified, for example by applying “weights” to the different entities. Weight in this context means that a numeric value could be associated with each entity, for example in a range from 0 to 10, or with a percentage (%) that indicates how important the entity is considered in terms of the documents to be retrieved. A high score, in this case, could imply that the user considers that the selected entity is particularly relevant, whereas a low score would indicate that the chosen entity is not of major importance. For example, if an entity E1 was added with a weight of 80% and entity E2 was added with a weight of 40%, this would imply that for the user E1 is twice as important as E2. When generating the search results, the search results that contain entities having higher weightings will be given more prominence than results containing entities with lower weightings. The prominence of a result can be adjusted by changing the way a link to the result is displayed (e.g., by bolding or underling the result, or including an image depicting at least a portion of the contents of the search result) or by changing the order of results so that more highly weighted results are listed earlier in the result set.

The query, once constructed, can be expressed in different manners. Taking the Boolean example of AND/NOT restrictions, one option is to express the query as the combination of two sets of entities, which represent the “AND” and the “NOT” restrictions. For example, Query=AND (E1, E2, . . . , En)+NOT (E′1, E′2, . . . E′n), where E1 to En are the knowledge model entities that the user has specified that have to appear in the results, and E′1 to E′n are the knowledge model entities that the user has specified that cannot appear in the results. On the other hand, if the restrictions are applied by specifying weight to each entity, for example through a percentage, one possibility would be to express the query through entity-weight pairs: Query={(E1, X1), (E2, X2) . . . (En, Xn)}, being E1 to En the entities onto which the user has specified weights, and X1 to Xn the respective weights associated to each of the entities.

Once constructed, the query (however structured) is executed against the index of the knowledge base, obtaining a set of results that comply with the restrictions specified in the query. Accordingly, in the case of “AND” and “NOT” restrictions, every document returned by the query will have been annotated with the entities in the “AND” set, and at the same time none of the returned documents will have been annotated with the entities in the “NOT” set. For more complex restrictions (such as weight-based restrictions), the search engine computes the scores for each document based on the restrictions applied, and selects the most relevant ones. The results are then returned and presented to the user for their inspection.

### EXAMPLE

The following is an example of how the present system may be utilized by a user to perform a search of a knowledge base. The following example is merely presented to provide an example operation of the system and should not be considered limiting of the present disclosure. For example, a particular knowledge domain (i.e., the cinema) has been selected, though the present system could operate in any knowledge domain for which a suitable knowledge model exists. Besides the arbitrary knowledge domain, some other decisions have been taken for the sake of illustrating the present example. For example, the fact that two types of entities (concepts and instances) and three types of relations (explicit relationship, hierarchy, belongs to) are used is a completely subjective decision as the present system could utilize a knowledge model having a different number of entities and/or relations. The also applies to the way in which the entities and relationships are depicted, or how the entities are expanded, or the types of restrictions (“AND” and “NOT”) available and how they are specified, etc.

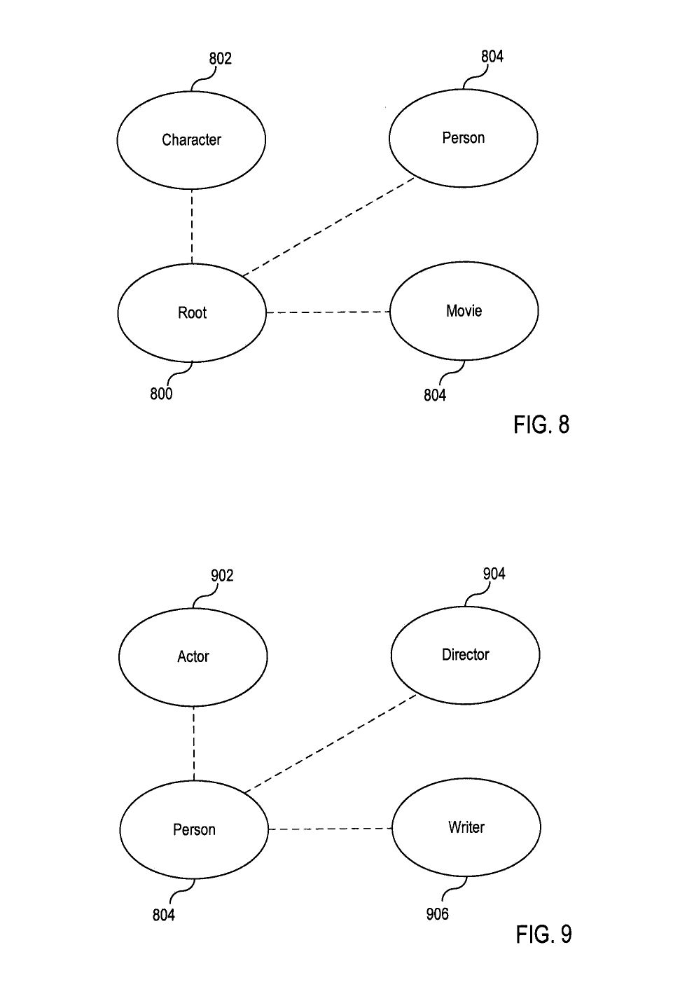

When a user first begins constructing a query, the user is presented with an initial view of the relevant knowledge model. FIG. 8 shows an initial user interface depicting the root knowledge model graph of the present cinema knowledge model. The graph depicts the three high-level concepts available in the ontology, namely Character 802, Person 804 and Movie 804, connected to the ontology root 806 with dotted lines. In this example, the dotted lines indicate a hierarchy relation. Accordingly, the lines indicate that the Character 802, Person 804 and Movie 804 concepts are related to the root 806 via the knowledge model's hierarch.

The graph of FIG. 8 may be presented to the user via a suitable user interface implemented by, for example, client 102. The user interface may allow the user to pan about the graph, or zoom in/out of the graph. The user interface also allows the user to select at least one of the entities depicted on the graph and then execute one or more actions on the selected entity. The actions may be performed by clicking on the entity, mousing over the entity, performing particular keystrokes on a keyboard, or combinations thereof. Other alternative user interface techniques and devices may be used in conjunction with the user interface provided by client 102. In this example, the user selects and expands the “Person” concept 804.

After the user has selected and expanded the Person concept, the knowledge model graph is recreated with a focus on the Person concept. Accordingly, entities falling underneath the Person concept become depicted on the user interface and concepts not directly related to the Person concept are no longer depicted. FIG. 9 shows the knowledge model graph after being focused on the selected Person concept. As depicted, the new graph features the three hierarchy relationships (subclasses), namely the Actor 902, Director 904 and Writer 906 concepts by the use of dotted lines. In this example, the dotted lines indicate a hierarchy relation. Accordingly, the lines indicate that the Actor 902, Director 904 and Writer 906 concepts are related to the Person concept via the knowledge model's hierarchy. In this example, the user selects and expands the Actor 902 concept.

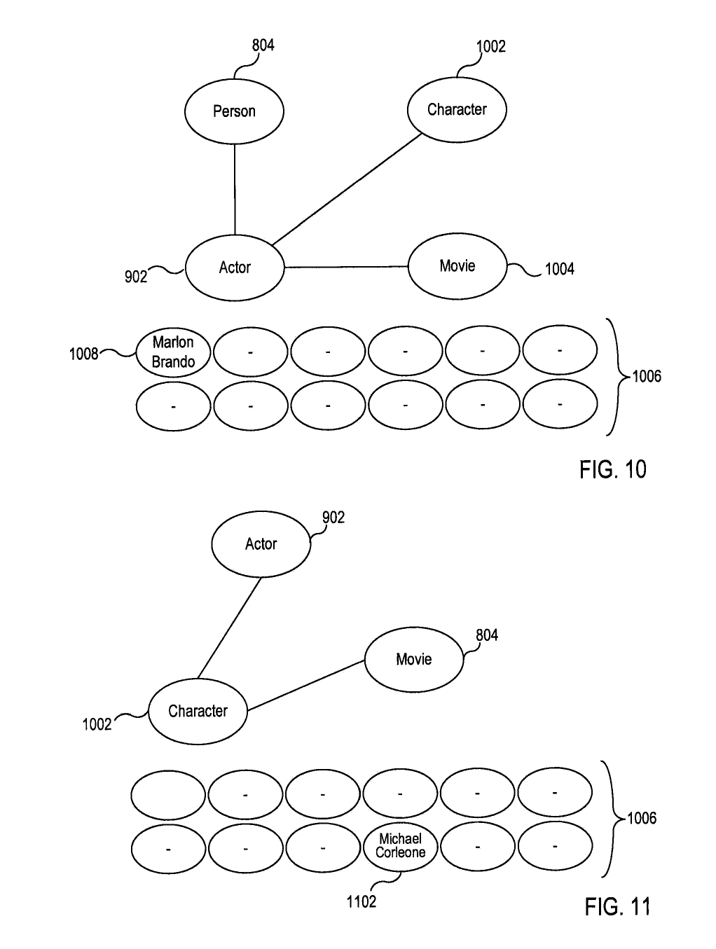

After the user has selected and expanded the Actor 902 concept, the knowledge model graph is recreated with a focus on the Actor 902 concept. Accordingly, entities falling underneath the Actor 902 concept become depicted on the user interface and concepts not directly related to the Actor 902 concept are no longer depicted. FIG. 10 shows the knowledge model graph after being focused on the selected Actor 902 concept. As depicted, the new graph depicts a hierarchical link (dotted line) to Person 804 concept, which is now a superclass to Actor 902 concept. The graph also depicts two direct relationships to the Character concept 1002 and Movie concept 1004 (respectively, “plays role” and “appears in” relationships) with solid lines.

In the graph of FIG. 10, because there are a number of instances that are related to the Actor concept 902, the graph includes a listing of instances 1006. The listing of instances includes a number of instances that fall below to the selected concept in the knowledge base. In this case, the Actor concept 902 is selected, so the listing of instances 1006 will include actual instances of actors. In this example, the only instance is the “Marlon Brando” instance 1008.

In this example, the user selects the Marlon Brando instance 1008. The user then adds the instance to the query with an associated “AND” restriction. At this time the query only includes a single item (“Marlon Brando”). Accordingly, if the user were the execute the search now, the results would include all items that are associated with Marlon Brando (either because they include those words directly, or because the item is associated with metadata that mentions Marlon Brando).

After adding “Marlin Brando” to the query with an AND restriction, the user selects and expands the Character concept 1002.

After the user has selected and expanded the Character concept 1002, the knowledge model graph is recreated with a focus on the Character concept 1002. Accordingly, entities falling underneath or related to the Character concept 1002 become depicted on the user interface and concepts not directly related to the Character concept 1002 are no longer depicted. FIG. 11 shows the knowledge model graph after being focused on the selected Character concept 1002. The graph depicts two direct relationships (solid lines) to the Actor concept 902 and the Movie concept 804 (respectively, “is played by” and “is character of” relationships). Additionally, the graph includes a listing of instances 1006 that belong to the Character concept 1002. Again, they have been arbitrarily featured below the graph, and only one instance (“Michael Corleone”) 1102 has been labeled in the figure.

In the example, the user selects the Michael Corleone instance 1102 and adds the instance to the query and associates an “AND” restriction with the instance. At this time the query includes two items, each with AND restrictions (“Marlon Brando” and “Michael Corleone”). Accordingly, if the user were to execute the search now, the results would include all items that are associated with both Marlon Brando and Michael Corleone (either because they include those words directly, or because the item is associated with metadata that mentions both instances).

The user then selects and expands the Michael Corleone instance 1102.

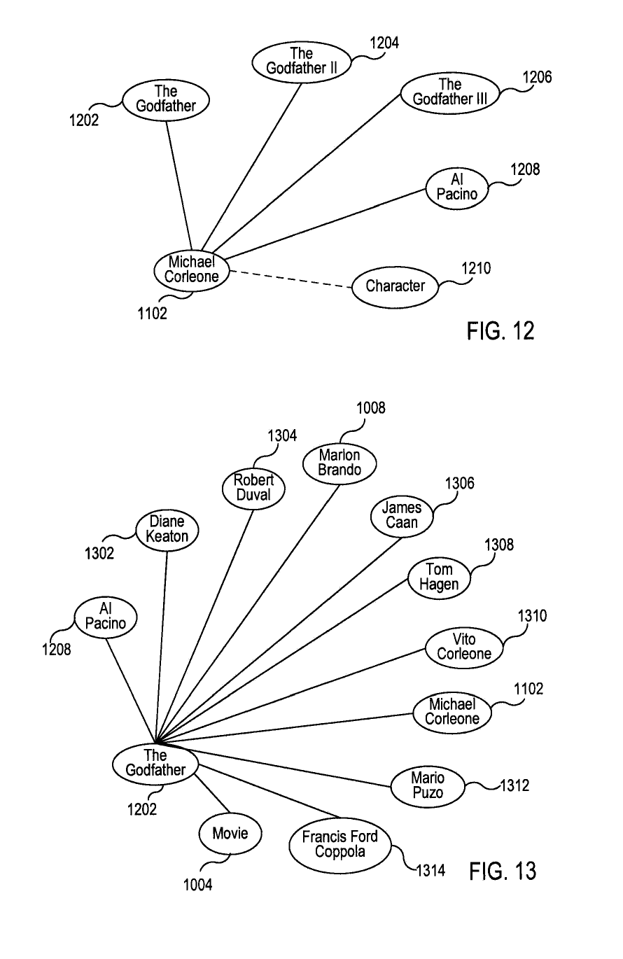

After the user has selected and expanded the Michael Corleone instance 1102, the knowledge model graph is recreated with a focus on the Michael Corleone instance 1102. Accordingly, entities falling underneath or related to the Michael Corleone instance 1102 become depicted on the user interface and concepts or instances not directly related to the Michael Corleone instance 1102 are no longer depicted. FIG. 12 shows the knowledge model graph after being focused on the selected Michael Corleone instance 1102. In this case, other instances that have a direct relationship to the selected one are also depicted including The Godfather instance 1202, The Godfather II instance 1204 and The Godfather III instance 1206 (through the “is character of” relationship) and the Al Pacino instance 1208 (through the “is played by” relationship) via solid lines. Additionally, the Character concept 1210 is depicted through the “belongs to” relation, using a dashed line.

In this example the user selects The Godfather III instance 1206 and adds the instance to the query and associates a “NOT” restriction with the instance. At this time the query includes three items, two with AND restrictions (“Marlon Brando” and “Michael Corleone”) and one with a NOT restriction (“The Godfather III”). Accordingly, if the user were to execute the search now, the results would include all items that are associated with both Marlon Brando and Michael Corleone (either because they include those words directly, or because the item is associated with metadata that mentions both instances) except those that are associated with The Godfather III.

The user then selects and expands the The Godfather instance 1202. After the user has selected and expanded the The Godfather instance 1202, the knowledge model graph is recreated with a focus on the The Godfather instance 1202. Accordingly, entities falling underneath or related to the The Godfather instance 1202 become depicted on the user interface and concepts or instances not directly related to the The Godfather instance 1202 are no longer depicted. FIG. 13 shows the knowledge model graph after being focused on the selected The Godfather instance 1202, featuring the instances that have a direct relationship to the selected The Godfather instance 1202 including the Al Pacino instance 1208, the Diane Keaton instance 1302, the Robert Duvall instance 1304, the Marlon Brando instance 1008 and the James Caan instance 1306 of the Actor concept (through the “features” relationship); the Tom Hagen instance 1308, the Vito Corleone instance 1310 and the Michael Corleone instance 1102 of the “Character” concept (through the “has character” relationship); the Mario Puzo instance 1312 of the Writer concept (through the “has writer” relationship); the Francis Ford Coppola instance 1314 of the Director concept (through the “has director” relationship). Additionally, the Movie concept 1004 is depicted through the “belongs to” relation depicted with a dashed line.

In the example the user selects the “Robert Duvall” instance 1304 and adds the instance to the query and associates an “AND” restriction with the instance. At this time the query includes four items, three with AND restrictions (“Marlon Brando,” “Michael Corleone,” and “Robert Duvall”) and one with a NOT restriction (“The Godfather III”). Accordingly, if the user were to execute the search now, the results would include all items that are associated with Marlon Brando, Michael Corleone, and Robert Duvall (either because they include those words directly, or because the item is associated with metadata that mentions both instances) except those that are associated with The Godfather III.

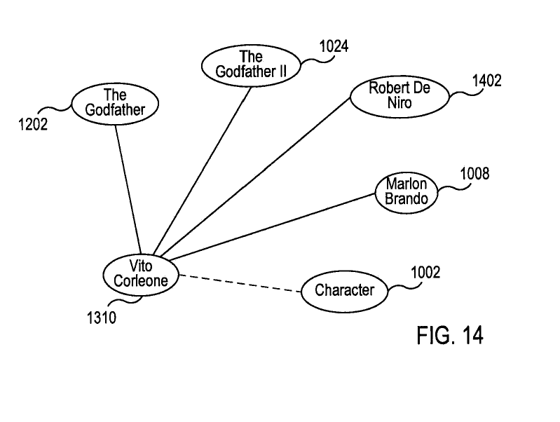

The user then selects and expands the Vito Corleone instance 1310. After the user has selected and expanded the Vito Corleone instance 1310, the knowledge model graph is recreated with a focus on the Vito Corleone instance 1310. Accordingly, entities falling underneath or related to the Vito Corleone instance 1310 become depicted on the user interface and concepts or instances not directly related to the Vito Corleone instance 1310 are no longer depicted. FIG. 14 shows the knowledge model graph after being focused on the selected Vito Corleone instance 1310, featuring the related instances: the The Godfather instance 1202 and the The Godfather II instance 1204 of the Movie concept (through the “is character of” relationship); the Robert De Niro instance 1402 and the Marlon Brando instance 1008 of the “Actor” concept (through the “is played by” relationship). Additionally, the “Character” concept 1002 is depicted through the “belongs to” relation with a dashed line.

At this time, the user decides to stop browsing and triggers the search with the query that has been generated.

At this time the generated query could then be represented as Query=AND (“Marlon Brando”, “Michael Corleone”, “Robert Duvall”)+NOT (“The Godfather III”). After executing the query, a set of items from the knowledge base is returned to the user (e.g., via client 102). The items in the resulting set may include any type of content (e.g., text, webpage, multimedia (video, audio, etc.)) that all conform to the restrictions specified in the query along the browsing through the knowledge model, i.e., all the documents in the set have been annotated with the “Marlon Brando”, “Michael Corleone” and “Robert Duvall” entities, but none of which has been annotated with “The Godfather III” instance.

Although the present invention has been described with respect to preferred embodiment(s), any person skilled in the art will recognize that changes may be made in form and detail, and equivalents may be substituted for elements of the invention without departing from the spirit and scope of the invention. Therefore, it is intended that the invention not be limited to the particular embodiments disclosed for carrying out this invention, but will include all embodiments falling within the scope of the appended claims.

What is claimed is:

1. An information retrieval system, comprising:
a knowledge model database configured to store a knowledge model for a knowledge domain, the knowledge model defining a plurality of entities and interrelationships between one or more of the plurality of entities;
a knowledge base configured to:
identify a plurality of items, and
associate at least one of the plurality of items with at one of the entities in the knowledge model;
a graph generation module configured to output, to a client computer, a graph depicting a first arrangement of a subset of the plurality of entities of the knowledge model, the graph depicting a relationship between ones of the subset of the plurality of entities;
a node selection reception module configured to receive, from the client computer, a selection of at least one of the subset of the plurality of entities and an associated action, wherein, when the associated action is of a first type, the graph generation module is configured to output, to the client computer, a second graph depicting a second arrangement of a second subset of the plurality of entities of the knowledge model using the selected at least one of the subset of the plurality of entities; and
a query generation module configured to, when the associated action is of a second type, generate a query string using the selected at least one of the subset of the plurality of entities.

2. The system of claim 1, including a knowledge base search module configured to execute a search of the knowledge base using the query string.

3. The system of claim 1, wherein the node selection reception module is also configured to receive, from the client computer, a restriction associated with the selected at least one of the subset of the plurality of entities.

4. The system of claim 3, wherein the restriction is a Boolean restriction.

5. The system of claim 3, wherein the restriction includes a weighting.

6. The system of claim 5, wherein the weighting is used to determine a prominence of an entity in a set of search results generated using the query string.

7. An information retrieval system, comprising:
a graph generation module configured to output, to a client computer, a graph depicting a first arrangement of a subset of a plurality of entities of a knowledge model, the graph depicting a relationship between ones of the subset of the plurality of entities;
a node selection reception module configured to receive, from the client computer, a selection of at least one of the subset of the plurality of entities and an associated action, wherein, when the associated action is of a first type, the graph generation module is configured to output, to the client computer, a second graph depicting a second arrangement of a second subset of the plurality of entities of the knowledge model using the selected at least one of the subset of the plurality of entities; and
a query generation module configured to, when the associated action is of a second type, generate a query string using the selected at least one of the subset of the plurality of entities.

8. The system of claim 7, wherein the knowledge model defines a plurality of entities and interrelationships between one or more of the plurality of entities.

9. The system of claim 7, including a knowledge base search module configured to execute a search of the knowledge base using the query string.

10. The system of claim 7, wherein the node selection reception module is also configured to receive, from the client computer, a restriction associated with the selected at least one of the subset of the plurality of entities.

11. The system of claim 10, wherein the restriction is a Boolean restriction.

12. The system of claim 10, wherein the restriction includes a weighting.

13. The system of claim 12, wherein the weighting is used to determine a prominence of an entity in a set of search results generated using the query string.

14. A method, comprising:
providing a knowledge model database configured to store a knowledge model for a knowledge domain;
outputting, to a client computer, a graph depicting a first arrangement of a subset of a plurality of entities of the knowledge model, the graph depicting a relationship between ones of the subset of the plurality of entities;
receiving, from the client computer, a selection of at least one of the subset of the plurality of entities and an associated action;
when the associated action is of a first type, outputting, to the client computer, a second graph depicting a second arrangement of a second subset of the plurality of entities of the knowledge model using the selected at least one of the subset of the plurality of entities; and
when the associated action is of a second type, generating a query string using the selected at least one of the subset of the plurality of entities.

15. The method of claim 14, including a knowledge base search module configured to execute a search of the knowledge base using the query string.

16. The method of claim 14, wherein the node selection reception module is also configured to receive, from the client computer, a restriction associated with the selected at least one of the subset of the plurality of entities.

17. The method of claim 16, wherein the restriction is a Boolean restriction.

18. The method of claim 16, wherein the restriction includes a weighting.

19. The method of claim 18, wherein the weighting is used to determine a prominence of an entity in a set of search results generated using the query string.
